(19) United States
(12) Patent Application Publication
(10) Pub. No.: US 2013/0210070 A1
(43) Pub. Date: Aug. 15, 2013

(54) MICROFLUIDIC DEVICE AND METHOD FOR CONTROLLING INTERACTION BETWEEN LIQUIDS

(71) Applicants: Anders Hentzell, Linköping (SE); Daniel Forchheimer, Linköping (SE); Magnus Berggren, Vreta Kloster (SE); Agneta Richter-Dahlfors, Saltsjö-Boo (SE); Edwin Jager, Linköping (SE); Peter Kjäll, Lidingö (SE)

(72) Inventors: Anders Hentzell, Linköping (SE); Daniel Forchheimer, Linköping (SE); Magnus Berggren, Vreta Kloster (SE); Agneta Richter-Dahlfors, Saltsjö-Boo (SE); Edwin Jager, Linköping (SE); Peter Kjäll, Lidingö (SE)

(21) Appl. No.: 13/814,068

(22) PCT Filed: Aug. 5, 2011
(86) PCT No.: PCT/SE2011/050981

§ 371 Date: Apr. 19, 2013

Related U.S. Application Data
(60) Provisional application No. 61/371,248, filed on Aug. 6, 2010.

(30) Foreign Application Priority Data
Aug. 6, 2010 (SE) 1050843-0

(51) Int. Cl. B01L 3/00; G01N 1/30; G01N 1/38; G01N 1/31

(52) U.S. Cl. CPC B01L 3/502738; G01N 1/31; G01N 1/30; G01N 1/38
USPC 435/40.5; 422/502; 436/174

(57) ABSTRACT

A microfiuidic device comprises a valve having electrically controllable wetting properties. The valve comprises a valve surface arranged in a closed valve space defined by at least the valve surface, a first liquid opening for leading a first liquid to the valve and a second liquid opening for leading a second liquid to the valve. The valve surface, in a first state, is sufficiently hydrophobic to prevent contact between the first liquid and the second liquid. The valve surface, in a second state, is sufficiently hydrophilic to allow contact between the first liquid and the second liquid. A ventilation outlet is provided for allowing gas to escape from the valve space.

### TECHNICAL FIELD

The present disclosure relates to a microfluidic device and in particular to a microfluidic device, which can be used to control fluids in a system while studied in e.g. a microscope.

The disclosure also relates to a microscope slide, on which such a microfluidic device may be implemented.

Furthermore, the disclosure relates to a method for controlling interaction between liquids.

### BACKGROUND

Devices that perform a biological or chemical reaction by manipulating a small volume of a fluid are referred to as microfluidic devices. Microfluidic structures and systems are useful for many purposes, including such applications as chemical and biochemical sensing systems, protein and chemical synthesis, spectroscopy of ultra-small volumes and visualization of reactions in in vitro experiments. However, in conventional microfluidic systems, pneumatic pressure lines with external macroscopic valves are commonly used to actuate the components such as valves and pumps that control or perform various microfluidic functions that need to occur to make the processes work. Microfluidic structures may e.g. include chambers that can hold a fluid, channels through which the fluid can flow, reaction sites or chambers, sensor areas and valves that can control the flow of the fluid.

In order to perform complicated processes in microfluidic devices, a plurality of microfluidic valves that are disposed at various positions may be use to control the flow of a fluid. Also, in order to mass produce the microfluidic devices, a method of efficient and cost effective manufacturing of the microfluidic valves together with chambers and channels is desired. There is hence a general need for miniaturized valves which can be used in microfluidic systems, for example to permit such systems to be reduced in size, weight and cost of fabrication.

Cell-based assays are a vital part of molecular biology and new platforms for cell-based assays are emerging every day. The ability to facilitate and expand the areas of use as well as perform diversified experiments in ordinary microscopes are key factors for future devices. New devices will have precise environmental control in solution exchange and chemical gradient experiments coupled with real-time observation and the ability to perform time-lapse, high magnification imaging of adherent cells.

A “cell-based assay” is understood to include but is not limited to e.g. cell-based experiments involving methods of immunostaining, migration studies, secretion studies, apoptosis studies and chemosensitivity studies on samples such as biopsy or tissue samples cell cultures and single cells. A cell based assay is in this context also understood to include studies of bacteria and molecules.

The establishment of contact between two or more solutions in microfluidic structures is of vital importance to achieve precise spatial and temporal control of e.g. solution exchange or diffusion build-up of chemical gradients. Changing experiment parameters during an ongoing experiment is virtually impossible in ordinary microscope set-ups where samples that are immobilized on microscope slides are studied. One would have to remove the slide and prepare a new sample. It is hard to find the same cells and keep all parameters equal when doing this.

Chemotaxis, the movement of cells in the direction of a chemical gradient, is a fundamental process in inflammation. Quantitative measurements of number of cells migrating along a stable chemical gradient and their traveled distance may provide important insight into the ratio of infections or spreading of infectious agents in organisms. Today these experiments are performed with e.g. a Boyden chamber set-up. The creation of controlled chemical gradients in microfluidics often includes cumbersome handling with the devices that are available today. Pipettes are used to introduce liquids at different ports with other ports being blocked by caps. If the device is moved or the caps are put on too hard the experiment conditions may be affected negatively. There is also a risk of leakage associated with complicated handling of a device.

When cells are studied on a microscope slide they are generally wedged between the slide and a cover glass. This makes it almost impossible to stimulate the cells in a controlled way. The user would have to either lift the cover glass and drop the stimuli on top of the cells or apply a solution containing the stimuli at the edge of the cover glass and rely on diffusion in the thin liquid layer between cover glass and slide. Either one of these methods means cumbersome handling and the addition of unknown parameters that might affect experiment quality and reliability.

Prior art propose the use of a flow chamber for some of these experiments but flow chambers have a number of negative aspects including excessive flow that may affect the behavior of adhered cells, large solution volumes and no spatial control and insufficient temporal control of addition of liquids. Flow chambers are typically used to study shear forces on adhered cells in a flowing medium. Flow chambers also require external flow control hardware like pumps.

U.S. Pat. No. 7,517,499B2 and U.S. Pat. No. 7,582,264B2 disclose microscope slides with channel arrangements allowing for some user interaction with the studied object during microscope study.

However, there is a need for improving the possibility for the user to interact with a system while studying it in e.g. a microscope.

### SUMMARY

It is a general object of the present disclosure to provide an improved system for delivery of a fluid in a microfluidic system.

It is a specific object to provide an improved fluid delivery system which allows for user interaction with a system while studying it in e.g. a microscope.

The invention is defined by the appended independent claims. Embodiments are set forth in the appended dependent claims, in the following description and in the drawings.

Hence, there is provided a microfluidic device comprising a valve having electrically controllable wetting properties. The valve comprises a valve surface arranged in a closed valve space defined by at least the valve surface, a first liquid opening for leading a first liquid to the valve and and a second liquid opening for leading a second liquid to the valve. The valve surface, in a first state, is sufficiently hydrophobic to prevent contact between the first liquid and the second liquid. The valve surface, in a second state, is sufficiently hydrophilic to allow contact between the first liquid and the second liquid. A ventilation outlet is provided for allowing gas to escape from the valve space.

A “valve presenting electrically controllable wetting properties” may be achieved either by modifying the surface of the valve, as will be described in more detail herein. However, it is also possible to modify wettability properties by affecting the liquid, e.g. by applying an electric field across it.

A microfluidic device is made to exercise precise control and manipulation of fluids that are geometrically constrained to a small, typically sub-millimeter, scale. On the microscale the behavior of fluids may differ from ‘macrofluidic’ behavior in that factors such as surface tension, energy dissipation, and fluidic resistance start to dominate the system.

The valve space is closed from interaction with the surrounding environment but for the ventilation outlet and the liquid openings. In use, however, the liquid openings will be blocked by surfaces of the liquids. Hence, but for the ventilation outlet, gas (e.g. air) present in the valve space would prevent the liquids from meeting.

The microfluidic device is thus able to control the interaction between two or more liquids, while allowing a user to study the effects of the interaction in e.g. a microscope or any other type of magnification or detection device.

The valve surface may be selected and/or tuned to cooperate with the specific liquids for which the valve is to be used.

In one embodiment, a valve surface may be provided with an electroactive polymer arranged as a surface layer in at least a part of the valve space, e.g. a part towards which the gravitational force of the liquids is directed.

In another embodiment the valve surface may be provided with one or more surface active molecules, as disclosed in U.S.2008/0223717A1.

The valve space may present a first opening for access to the first liquid and a second opening for access to the second liquid.

The valve space may have a third opening forming the ventilation outlet.

The third opening may, but need not, be positioned outside a space spanned by the first and second openings.

The first and third openings may be positioned on opposite sides of a plane extending substantially perpendicular to a plane defining the second opening.

The microfluidic device may further comprise at least one receptacle and at least one channel, which is in fluid connection with the receptacle, wherein the channel and the receptacle define a main plane.

The ventilation outlet may open in a direction substantially perpendicular to the main plane. Alternatively, the ventilation outlet may open in a direction substantially parallel with the main plane.

The channel may present at least one surface portion which is effectively hydrophilic.

The electroactive polymer may be formed as an extension of the hydrophilic surface portion.

The channel may be adapted to convey the second liquid mainly by capillary action.

The receptacle may be a target receptacle, adapted to hold the first liquid.

The valve may be arranged in direct connection to the target receptacle.

A drain may be in fluidic communication with the receptacle.

Means may be provided for controlling a volume drawn by the drain. Thus, the volume drawn into a target receptacle may be precisely controlled.

The microfluidic device may further comprise a source receptacle, which is connectable to the target receptacle via the channel and the valve. The source receptacle may be open or openable to the surrounding environment, to allow introduction of a liquid into it.

The microfluidic device may further comprise a second channel and a second valve having electrically controllable wetting properties, where the second valve may be arranged to control a liquid flow in the second channel.

The second channel may be adapted to lead a third liquid to the receptacle. Hence a device presenting multiple source receptacles and one target receptacle may be provided.

The second channel may be connected to the source receptacle and adapted to lead the second liquid to a second target receptacle, which is adapted to hold a fourth liquid. Hence, a device comprising multiple target receptacles and one source receptacle may be provided.

The second channel may be connected to the source receptacle and to the target receptacle, thus providing a second connection between the source receptacle and the target receptacle. Hence, a second channel may be provided between a single source receptacle and a single target receptacle may be provided.

The microfluidic device may further comprise a second valve having electrically controllable wetting properties, where the second valve may be spaced from the first-mentioned valve, and arranged to control the flow of the second liquid in the channel. Hence, a channel having multiple valves may be provided.

The microfluidic device may further comprise a first electrode arranged in electronic contact with the electroactive polymer, and a second electrode, arranged upstream of the valve.

The microfluidic device may further comprise a first external contact, in electronic contact with the first electrode and a second external contact, in electronic contact with the second electrode. The contacts may be used to enable control or communication with external equipment.

The microfluidic device may further comprise a first channel portion, extending between the valve space and a first receptacle, adapted to hold the first liquid, and a second channel portion, extending between the valve space and a second receptacle, adapted to hold the second liquid.

The microfluidic device may further comprise a main receptacle, adapted to receive the first liquid, a main channel, extending from said main receptacle, and adapted to lead the first liquid from the main receptacle, a branch channel, connected to a downstream point of the main channel and adapted to lead a second liquid to said downstream point of the main channel; wherein the valve is arranged to control the flow of the second liquid to the main channel. Hence, an elongate channel with multiple functional areas may be provided.

Such a device may further comprise a second branch channel connected to a second downstream point of the main channel and adapted to lead a third liquid to said second downstream point of the main channel; and a second valve having electrically controllable wetting properties, the second valve being arranged to control the flow of the third liquid to the main channel.

The device may further comprise at least one main channel valve having electrically controllable wetting properties, the main channel valve being arranged to control the flow of the main liquid in the main channel.

The device may further comprise a main ventilation outlet for allowing gas to escape from the main channel valve.

The device may further comprise at least one sensor, amplification device, diluting device or additive provision device, arranged at a point along the main channel.

According to a second aspect, there is provided a system comprising a microfluidic device as described above, a first liquid, and a second liquid, wherein the second liquid contains a sufficient amount of ions to operate as an electrolyte for actuation of an electroactive polymer provided on the valve surface.

According to a third aspect, there is provided a method for controlling the interaction between a first and a second fluid in a microfluidic system, comprising providing the first liquid and the second liquid separated from each other by a closed valve space, presenting a valve surface, which, in a first state, is sufficiently hydrophobic to prevent the first and second liquids from contacting each other, modifying the wettability of the valve surface to render it sufficiently hydrophilic to allow the first and second liquids to contact each other, and venting gas trapped in the valve space.

According to a fourth aspect, there is provided a slide for microscopic study, comprising a carrier substrate, a slide cover, and a microfluidic device as described above, forming part of the slide.

In the slide at least one of the channel, the target receptacle and the ventilation outlet may be formed in the carrier substrate or in the slide cover.

In the slide an electroactive polymer may be provided on the carrier substrate or on the slide cover.

According to a fifth aspect, there is provided a slide for microscopic study, comprising a carrier substrate, a slide cover, a target receptacle, adapted to hold a first liquid; a channel, connected to the target receptacle and adapted to lead a second liquid to the target receptacle; and a valve comprising a valve surface presenting electrically controllable wetting properties.

The valve space may, but need not, be closed. The slide may further comprise a ventilation outlet for allowing gas to escape from the valve.

The channel may be adapted to convey the second liquid by capillary action.

The slide may further comprise a source receptacle, which is connectable to the target receptacle via the channel and valve.

The slide may further comprise a first electrode arranged in electronic contact with the electroactive polymer, and a second electrode, arranged upstream of the valve in the channel.

The slide may further comprise a first external contact, in electronic contact with the first electrode and a second external contact, in electronic contact with the second electrode.

The slide may further comprise a control interface, adapted for receiving a control signal for actuation of the valve.

The slide may further comprise a control device, adapted to receive the control signal and to provide an actuation signal for the valve.

According to a sixth aspect, there is provided a system comprising: a slide as described above, and a controller, adapted to communicate with the control interface.

In the system, the controller may be integrated with a microscope device.

The microscope device may comprise a data interface for communication with a processing unit, such as a computer.

According to a seventh aspect, there is provided a method for interaction with a liquid system on a microscope slide in a system as described above, comprising receiving a user input via a user input interface, and providing a control indication to the valve via the control interface in response to the user input.

The method may further comprise receiving an image of at least a part of the slide and presenting the image via a user presentation interface.

A “microscope device” is understood to include any type of imaging device allowing for the study of small objects, such as cells, bacteria, viruses, molecules. The term includes microscopes and magnifiers, regardless of the type of radiation used for the imaging (e.g. visual light, IR light, UV light, RF or X-ray radiation).

### BRIEF DESCRIPTION OF THE DRAWINGS

FIG. 1 is a schematic cross-sectional view along a channel of a microfluidic device.

FIGS. 2a-2c are schematic cross-sectional views along a channel according to different embodiments of a microfluidic device.

FIG. 3 is a schematic perspective view of a channel of a microfluidic device.

FIG. 4 is a schematic top view of an embodiment of a microfluidic device.

FIG. 5 is a schematic top view of another embodiment of a microfluidic device.

FIGS. 6a-6j are schematic top views of further embodiments of microfluidic devices.

FIGS. 7a and 7b are schematic top views of multi-channel embodiments of a microfluidic device.

FIG. 8 is a schematic top view of a microfluidic device having multiple source receptacles.

FIG. 9 is a schematic top view of a microfluidic device having multiple target receptacles.

FIG. 10 is a schematic top view of a linear microfluidic device.

FIGS. 11a-11g are schematic top views of various microfluidic devices integrated on a respective microscope slide.

FIGS. 12a-12d are schematic views of various microfluidic systems.

FIGS. 13a-13d are schematic views of different microscopic systems.

FIGS. 14a-14c are schematic views of different user interfaces.

### DESCRIPTION OF EMBODIMENTS

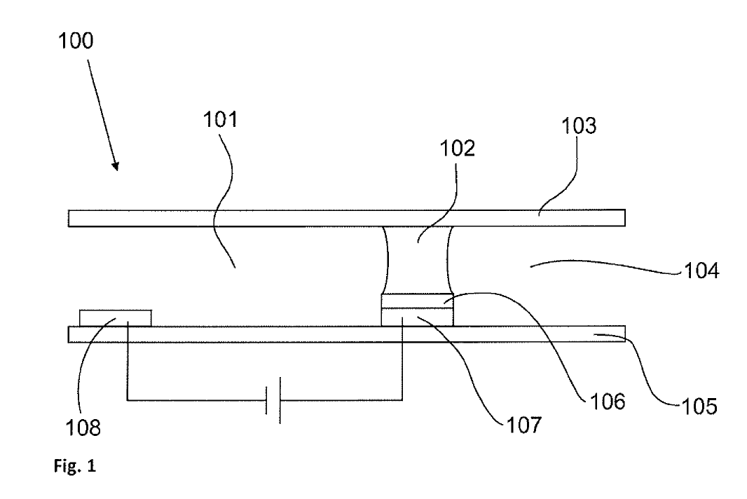

FIG. 1 shows a cross section along the length of the channel of a microfluidic device 100. 101 is an ion containing liquid. 102 is a closed valve space, typically containing air (or any other ambient gas in which the device is being used) trapped between the two liquids 101 and 104. 103 is the microfluidic structure that constitutes the substrate ceiling of the channel.

The microfluidic structure may be fabricated by any means of injection moulding, hot or soft embossing or computer numerical control (CNC) machining preferably in one of the following materials; polyvinyl chloride (PVC), polycarbonate (PC), acrylonitrile butadiene Styrene (ABS), polystyrene, polyethylene, polypropylene, poly dimethyl siloxane (PDMS), cyclic olefin copolymer (COC), polyimide, polyvinyl acetate (PVAc), polyethylene naphthalate, SU-8, thermoplastic rubber or thermoplastic polymers or copolymers. The fluidic structure may also be fabricated in glass, or silicon and the channels may be etched by wet chemical or dry etching as is known to those skilled in the art. This may require a bonding step where the etched channel structure is closed by a second layer of silicon, glass or plastic using standard bonding techniques including wafer bonding. In addition the channels may be formed by patternable (e.g. by photolithography) and curable resins or polymers such as SU-8.

The microfluidic structure may also be formed from a mould as is done using soft lithography where the microfluidic structure is made in a poly(dimethylsiloxane) (PDMS) slab. The preferred method of producing microfluidic structures with large channel widths is CNC machining. The preffered method for producing microfluidic structures with smaller channel widths (sub millimeter) is either injection moulding or hot or soft embossing.

The microfluidic structure surface may be functionalized to improve and/or impair wetting, protein and/or cell adhesion. This may be achieved by coating surfaces with e.g. lysine, collagen, fibronectin or the usage of any type of tissue culture (TC) treated surface, plasma treated or cleaned surface. 104 is a liquid that may or may not contain ions. 105 is a substrate.

The substrate may be of any of the following materials; paper, plastic, metal, silicon, or glass. Preferably, the substrate may comprise plastics, in particular optically high-grade and/or optically non-transparent plastics. Optically high-grade (i. e. without double refraction or autofluorescence or transparent in UV light) plastics reduces interfering influences of the substrate in for example fluorescence analyses; by the use of an optically non-transparent material, interferences due to undesired incident light from outside can be avoided.

Plastic substrate foils may comprise but are not limited to polychlorotrifluoroethylene (PCTFE) available commercially under the name Aclar, polyethylene terephthalate (PET) or polyethylene naphthalate (PEN) foils. Glass substrates may comprise but are not limited to borosilicate or quartz glass materials, including for instance glasses under the brand name Pyrex that are often used in MEMS fabrication. The substrate surface may be functionalized to improve and/or impair wetting, protein and/or cell adhesion. This may be achieved by coating surfaces with e.g. lysine, collagen, fibronectin or the usage of any type of tissue culture (TC) treated surface, plasma treated or cleaned surface. 106 is a patterned electroactive polymer valve.

The valve surface may be created/achieved by either subtractive or additive methods. Subtractive methods include wet and dry etching and lift-off. Additive methods include bonding techniques, casting, chemical vapor deposition, dip coating, sputter deposition, thermal evaporation and various types of printing. Preferred methods include any type of printing technique such as roll-to-roll printing, screen printing and inkjet printing.

Valve materials may constitute various types of polymers that electronically or electrochemically alter their wettability, including conjugated polymers such as polythiophenes, polypyrroles, polyanilines, polyisothianaphthalenes, polyphenylene, vinylenes and copolymers thereof. For the purpose of the present disclosure the preferred valve material may be found in the group of polythiophenes due to their printable properties.

107 is a working electrode. 108 is a counter electrode. The electrodes may be created/achieved by either subtractive or additive methods. Subtractive methods include but are not limited to both wet and dry etching methods and various types of mechanical processing such as turning, drilling, milling, grinding, honing, lapping, polishing and sawing, as are known to those skilled in the art. Additive methods include but are not limited to bonding techniques, casting, chemical vapor deposition, dip coating, sputter deposition, thermal evaporation and various types of printing. Preferred methods include any type of printing technique such as roll-to-roll printing, screen printing or inkjet printing. Electrode materials may constitute conducting oxide materials such as indium tin oxide (ITO), conducting metals such as gold, aluminum, platinum, titanium, chromium, copper, nickel or conducting plastic materials such as conjugated polymers, or conductive inks and pastes such as silver paint and carbon paste. Preferred electrode materials would be printable materials such as conducting plastics, pastes, or inks. When the liquid 101 is introduced into the channel, external force (the height of the liquid pillar), and/or capillary action and the hydrophilicity of the channel floor and/or walls draws it in to the electroactive polymer valve where it stops due to the hydrophobicity of the valve surface. The liquid 104 advancement is also capillary action driven from the other side of the valve. 103 and 105 enclose the liquids in the microfluidic system. If an electric potential is applied to the electrodes 107 and 108, the wettability of the electroactive polymer valve 106 is modified and the valve is activated and opened.

The counter electrode 108 may be placed anywhere within the microfluidic system as long as it is in ionic contact with the working electrode 107 through the electrolyte 101.

The bottom substrate 105 and channel substrate ceiling 103 may be made of glass or any other material, which is sufficiently transparent to the relevant type of radiation, such as a polymer material.

It is noted that the microfluidic structure may be provided in either or both of a pair of stacked, and optionally laminated, sheets.

It is understood that the above description on production technology and materials is applicable to all embodiments disclosed herein.

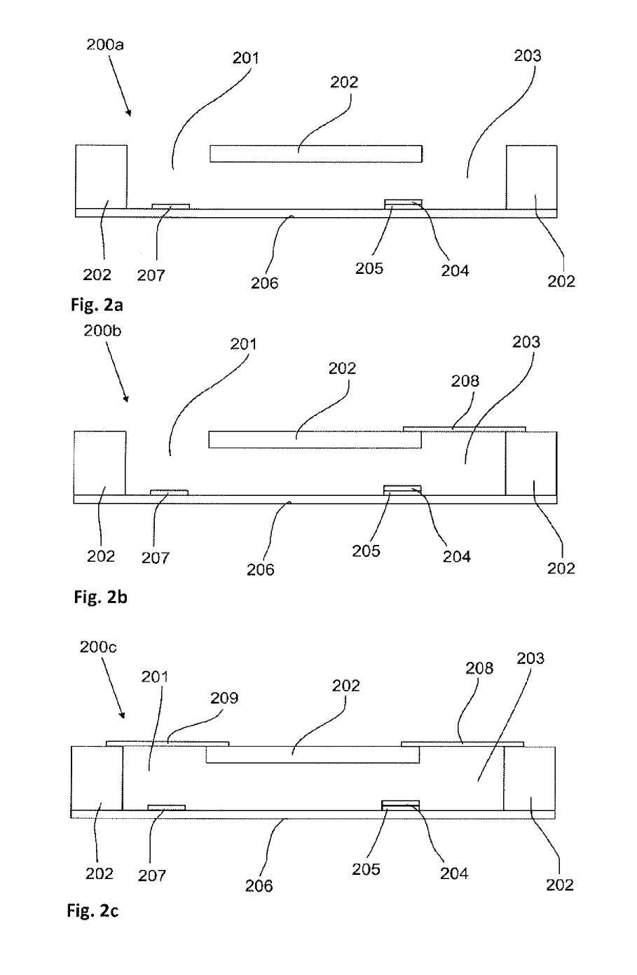

FIGS. 2a-2c show cross sections along the length of the channel of a microfluidic device, which is arranged on a substrate 206. The device comprises a source receptacle 201, a target receptacle 203, a microfluidic structure 202, an electrochemically active polymer valve 204, a working electrode 205, a device substrate 206, a counter electrode 207, and may further comprise a target receptacle cover 208 (FIG. 2b) and/or a source receptacle cover 209 (FIG. 2c). The covers 208, 209 may be made of a material such as glass or plastics previously described. The covers prevent undesired evaporation from source and target receptacles and may be used as viewing windows.

When a liquid is introduced into the source receptacle, gravitational force (the height of the liquid pillar) and/or capillary action draws it in towards the electroactive polymer valve where it stops. The target receptacle liquid advancement is also gravitational forces (the height of the liquid pillar) and/or capillary action driven from the other side of the valve. The microfluidic structure 202 encloses the liquids in the microfluidic system. If an electric potential is applied to the electrodes 205 and 207 the electrochemically active valve is activated and opened. By covering the source and/or target receptacles a confined volume is created. The device may be used in both upright and inverted microscopes.

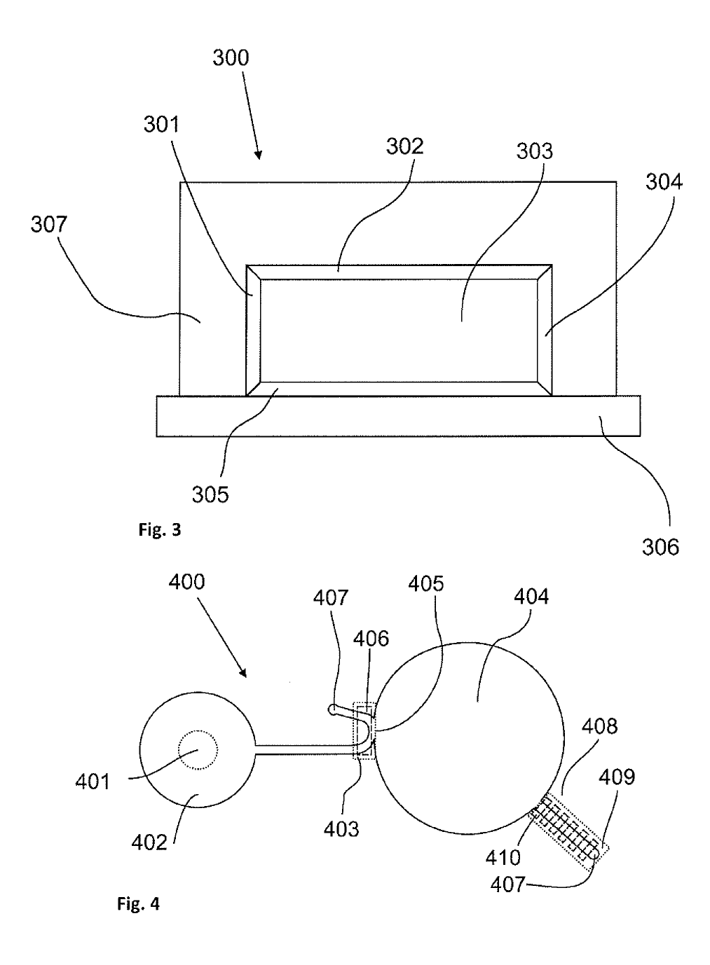

FIG. 3 shows a perspective view in the direction of a channel 303 comprising a first channel side wall 301, a channel inner ceiling 302, a second channel side wall 304, a channel floor 305, a device substrate 306 and a microfluidic structure 307.

Any single one or a combination of the inner walls 301, 304, the ceiling 302 or the floor 305 of the channel may be covered with the electrochemically active polymer valve.

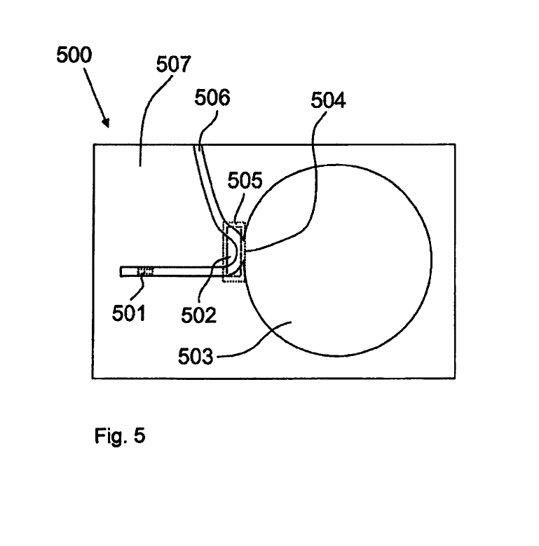

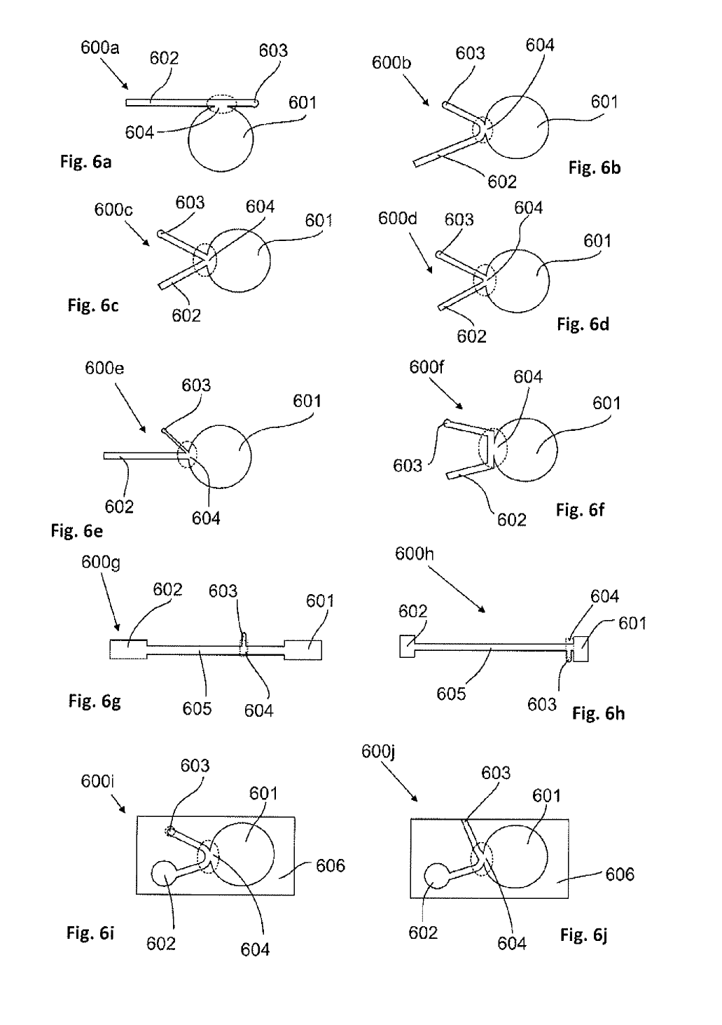

FIG. 4 shows a top view of the microfluidic structure comprising a counter electrode 401, a source receptacle 402, a working electrode 403, a target receptacle 404, an inlet opening 405, an electroactive polymer valve 406, an air venting outlet 407 that is open straight up, an excess liquid waste channel 408, a waste channel working electrode 409 and waste channel electroactive polymer valves 410. The microfluidic structure is supported by a substrate that has been left out for viewing convenience. The air ventilating structure is specific for this embodiment as compared to FIG. 5.

The waste channel may be used to induce delivery of a liquid via convection as opposed to diffusion. By allowing a well determined liquid volume to escape from the target receptacle into the waste channel the equal liquid volume is imbibed at the inlet opening. By placing several waste channel electroactive polymer valves in a row within the waste channel and activating a number of valves corresponding to a predetermined volume the imbibed liquid volume may be controlled.

FIG. 5 shows a top view of the microfluidic structure comprising a counter electrode 501, an electroactive polymer valve 502, a target receptacle 503, an inlet opening 504, a working electrode 505, and an air venting outlet 506 opening at the side of the substrate 507.

Compared to embodiment 4 embodiment 5 vents exhaust air out through the device side. This could be advantageous for easier production.

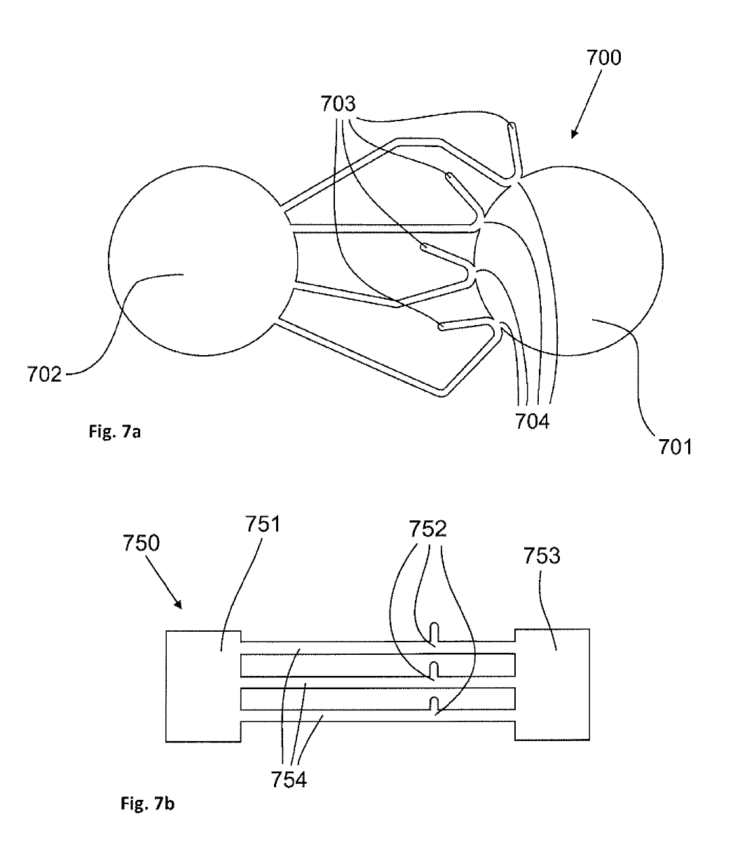

FIGS. 6a-6j show different geometries of the invention. Common parts for all FIGS. 6a-6j are 601-604 with; target receptacle 601, source receptacle 602, air venting outlet 603 and channel inlet 604. FIGS. 6g-6h also comprises a channel for creating controlled chemical gradients 605 in a straight channel. FIGS. 6i-6j in addition shows the substrate 606. The microfluidic structures in FIGS. 6a-6h are supported by a substrate that has been left out for viewing convenience.

FIGS. 6a-6f show different microfluidic structure geometries for the valve area. At each contact point between channel and target receptacle, there is a valve, as described with reference to e.g. FIG. 1. Either one of these geometries could be utilized or advantageous depending on how much space is available on the substrate.

FIG. 6a shows a straight channel that touch the circular shape of the target receptacle forming the valve area where the channel and receptacle are in contact.

FIG. 6b shows a straight channel with a bend at the channel-receptacle contact area.

FIG. 6c shows a channel-receptacle contact area in the shape of a cut off corner.

FIG. 6d shows a sectional channel with a similar channel-receptacle contact area as FIG. 6c.

FIG. 6e shows a straight channel leading directly in to the target receptacle but also featuring a narrower air venting channel starting in the valve contact area.

FIG. 6f shows a sectional channel with a similar channel-receptacle contact area as FIG. 6a.

FIGS. 6g-6h show microfluidic channel structures for creating chemical gradients. Gradients can either originate from one side of the connecting channel 6h or from anywhere along the channel length 6g.

FIGS. 6i-6j shows different air venting channel ends. FIG. 6i has a channel ending with a circular opening straight up from the substrate surface whereas FIG. 6j has an air venting channel ending on the substrate side. Either one of these could be advantageous depending on device fabrication technique.

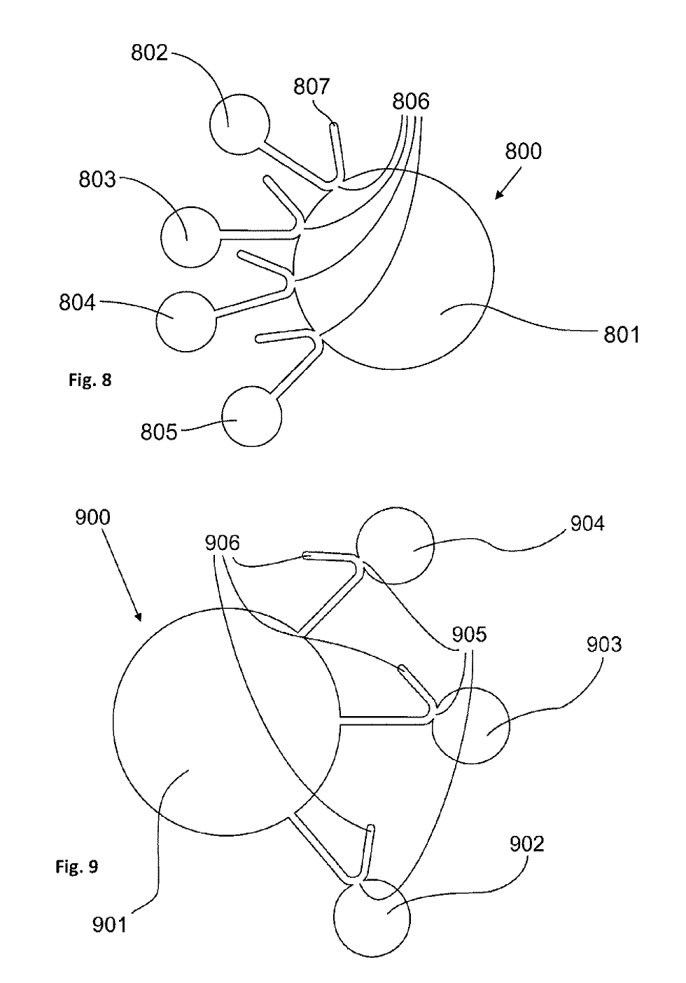

FIG. 7a shows a microfluidic channel structure comprising target receptacle 701, source receptacle 702, air ventilating outlets 703 and channel inlets 704. At each contact point between channel and target receptacle, there is a valve, as described with reference to e.g. FIG. 1.

The structure in FIG. 7a may be used for delivering one source electrolyte/liquid to several inlets on a target receptacle. There could be any number of inlets around a target receptacle. The target receptacle inlets 704 and air ventilating outlets may have any of the geometries described in detail in FIGS. 6a-6j.

FIG. 7b shows another microfluidic structure adapted for creating chemical gradients. The structure comprises source receptacles 751 and 753, ventilated valve controlled liquid contact areas 752 and microfluidic channels 754. At each contact 752 area, there is a valve, as described with reference to e.g. FIG. 1.

The microfluidic structures in FIGS. 7a-7b are supported by a substrate that has been left out for viewing convenience.

A respective liquid is added to the source receptacles 751 and 753. The liquids will be drawn by capillary action from both source receptacles into each channel towards the associated contact area 752. Upon actuation of the valve (not indicated here) the liquids will contact each other and a concentration gradient will build up in the respective channel.

Embodiment 7b may be used to create time-stable chemical gradients in straight channels. A liquid is filled in the source receptacle 751 and propagates into the channels 754 but stops at the valve contact areas 752. When a valve is activated and opened a chemical gradient starts to build up.

A solution containing live cells is introduced to the source receptacle 751 and is drawn into the channels 754. The solution stops at the valve contact areas 752 and the device may now be incubated for a period of time so that the cells adhere to the device substrate (not shown). A solution containing a chemical attractant may then be introduced into the second source receptacle 753 and drawn into the channels stopping at the valve contact areas 752. When a valve is activated and opened a fluid connection is created and a chemical gradient starts to build up and the adhered cells may start to migrate towards the gradient. If the embodiment is present on e.g. a microscope slide and an interesting section of the channel is placed in focus the cell migration in that section may be observed by means of filming or time-lapse imaging. The films and/or images may later be evaluated to extract information regarding number of cells migrating, their traveled distance and speed.

The valve controlled contact area may be placed anywhere along the length of the channel. Shapes and geometries may be designed as needed for any specific use.

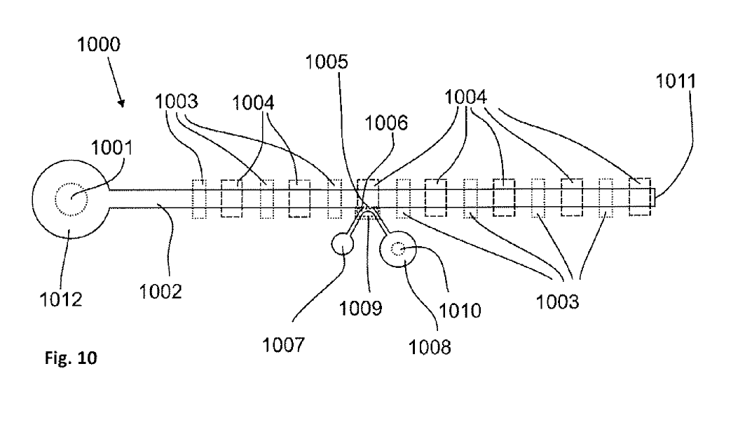

FIG. 8 shows a microfluidic structure comprising a target receptacle 801, a number of (e.g. two or more) source receptacles 802-805, channel inlets 806 and air ventilating outlet 807. There can be any number of source receptacles. At each contact point between channel and target receptacle, there is a valve, as described with reference to e.g. FIG. 1. The microfluidic structure is supported by a substrate that has been left out for viewing convenience.

The source receptacles may be filled with different source electrolytes. These liquids may be delivered to the target receptacle in sequence or all at once. By delivering liquids in sequence one could for example observe activation and deactivation of cell signal response. Furthermore, only one source receptacle may be activated. It may be that the target liquid, e.g. a cell culture, has one interesting spot, e.g. a certain cell or cell cluster that is particularly interesting, that the user wishes to stimulate. The receptacle corresponding to the valve exit closest to interesting spot may then be activated.

The target receptacle inlets may be placed as far or close apart as the application needs or as is possible to fit in due to space constrictions. The target receptacle inlets 806 and air ventilating outlets may have any geometry described in detail in FIGS. 6a-6j. The inlets may be distributed all around the circumference of the target receptacle (e.g. one at each 30 degrees) or only at a part of the circumference.

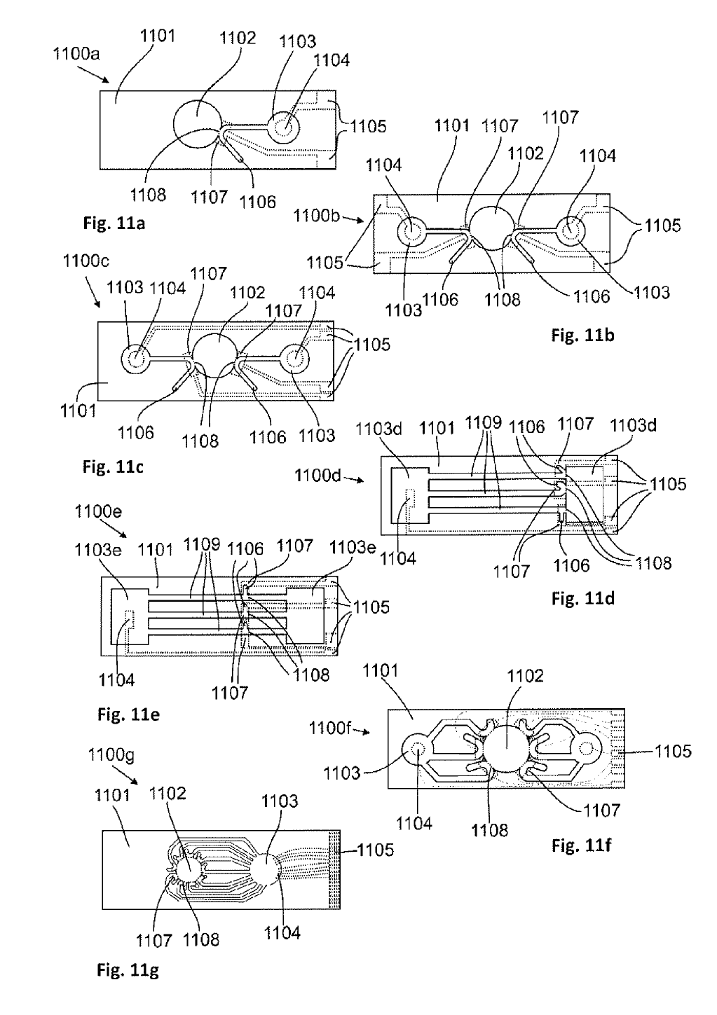

FIG. 9 shows a possible microfluidic structure comprising a source receptacle 901 a first target receptacle 902 a second target receptacle 903, a third target receptacle 904, channel inlets 905 and channel air outlets 906. There can be any number of target receptacles. At each contact point between channel and target receptacle, there is a valve, as described with reference to e.g. FIG. 1. The microfluidic structure is supported by a substrate that has been left out for viewing convenience.

Any source electrolyte can be delivered to any number of target receptacles. Target receptacles may contain different liquids or test samples. The target receptacle inlets 906 and air ventilating outlets may have any geometry described in detail in FIG. 6a-6j. In this embodiment, one solution of source electrolyte may be utilized to invoke response or action in a large number of target receptacles.

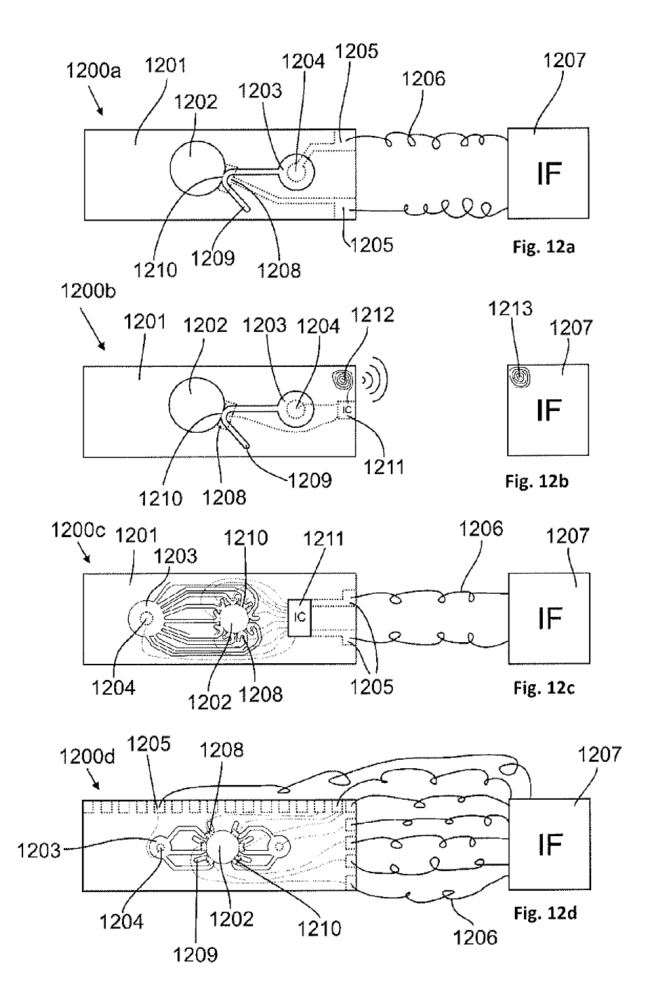

FIG. 10 shows a linear structure comprising counter electrodes 1001, 1010, a linear microfluidic channel 1002, working electrode with electroactive valve 1003, an electroactive valve 1006, a working electrode 1009, functionalized areas 1004, inlet 1005, air ventilating outlet 1007, additional source receptacle 1008, straight channel air outlet 1011, start receptacle 1012. The microfluidic structure is supported by a substrate that has been left out for viewing convenience.

Furthermore, the functionalized areas may be provided by either subtractive or additive methods. Subtractive methods include wet and dry etching and lift-off. Additive methods include bonding techniques, casting, chemical vapor deposition, dip coating, sputter deposition, thermal evaporation and various types of printing. Preferred methods include any type of printing technique such as roll-to-roll printing, screen printing and inkjet printing. A source electrolyte from the source receptacle may be guided to flow over a number of activated/functionalized areas separated by the electroactive valves. The structure comprising references 1006-1010 may be placed at any point along the length of the microfluidic channel 1002. The reaction between source electrolyte and functionalized area may be observed in sequence as one valve after another is activated and the source electrolyte advances through the channel.

The microfluidic channel may have any shape and the target channel inlet 1005 and air ventilating outlet may have any geometry described in detail in FIG. 6a-6j.

In this embodiment, one sample solution can be subjected to any number of tests or sample treatments as the solution advances over functionalized areas in the channel.

A sample is added in the start receptacle 1012 and may be guided into the channel 1002 by e.g. capillary action or a pressure induced by a liquid pillar formed in the source receptacle. The liquid stops at the first electro-active valve 1003-1 until this valve is opened. The liquid then passes a first functionalized area 1004 and stops at a second electroactive valve 1003-2. The procedure may be repeated as many times as the structure allows. The first functionalized area may comprise a sensor that measures a property of the liquid (biosensor, pH, conductivity, etc) or an amplification, dilution or a sample treatment step such as an amplification, dilution or addition step (e.g. add antigens or antibodies to the solution, change pH, etc).

This process can be repeated through several valves and functionalized areas 1003-2 through 1003-n 1004-2 through 1004-n, as indicated in FIG. 10.

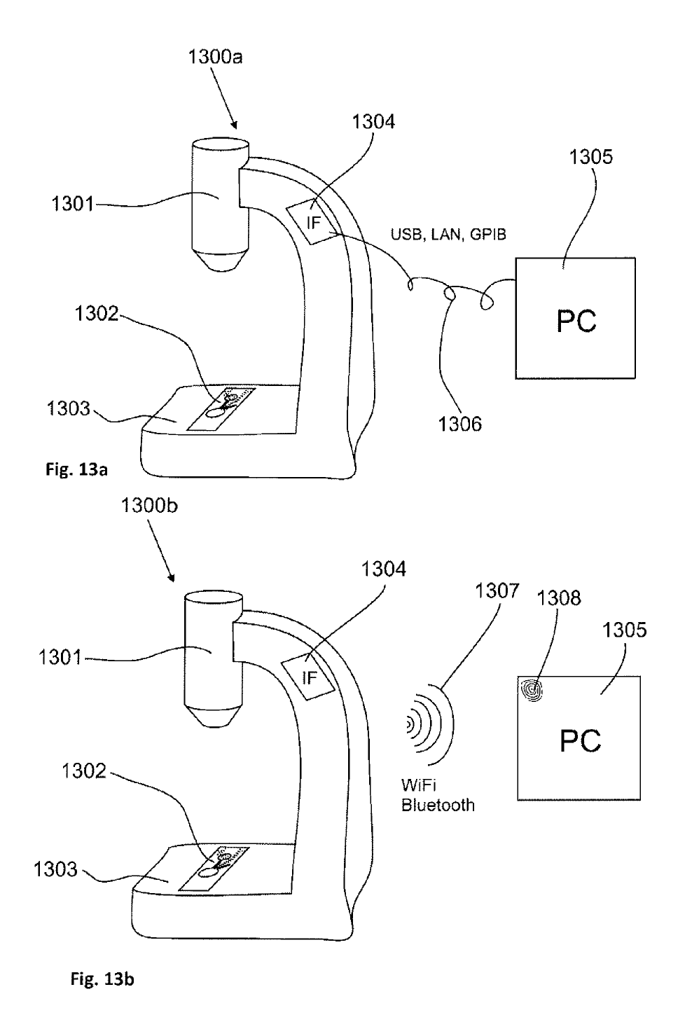

FIG. 11a-11g show different geometries of microfluidic devices integrated on a respective microscope slide comprising a microscope slide substrate 1101, target receptacle 1102, source receptacle 1103, counter electrode 1104, electrode contacts 1105, air vents 1106, working electrode 1107, channel inlet 1108, gradient channels 1109.

FIGS. 11a-11c show single (FIG. 11a) and double (FIGS. 11b-11c) inlet structures on microscope slides. These have different electrode contact sides with FIG. 11b showing double sided and FIGS. 11a and 11c showing single sided versions. These geometries may be used to deliver liquids to target receptacle inlets. The different appearances may be used depending on contact interfaces in the detection equipment. At each contact point between channel and target receptacle, there is a valve, as described with reference to e.g. FIG. 1.

FIGS. 11d-11e show microfluidic channel structures which may be used for creating chemical gradients. Gradients can either originate from one side of the connecting channel 11d or from anywhere along the channel length 11e. FIGS. 11d-11e show single sided electrode contacts.

FIG. 11f shows a microfluidic slide with two source receptacles and one target receptacle. There are three target receptacle inlets per source receptacle. This design may be used to deliver two different liquids to a sample placed in the target receptacle. Inlets may be placed anywhere along the target receptacle edge.

FIG. 11g shows a microfluidic slide with nine target receptacle inlets. Inlet valves may be activated in sequence to deliver source electrolyte to the target receptacle at predetermined intervals or only one spot/inlet may be chosen.

In these embodiments, the number of inlets, geometries and number of source and target receptacles may be varied according to what is desired for the specific application.

Hence, microscope slides with electronically controlled microfluidic valves may enable programmable experiments, experiments with less contamination and less variable parameters, since the user handling is eliminated from the moment of addition of solutions.

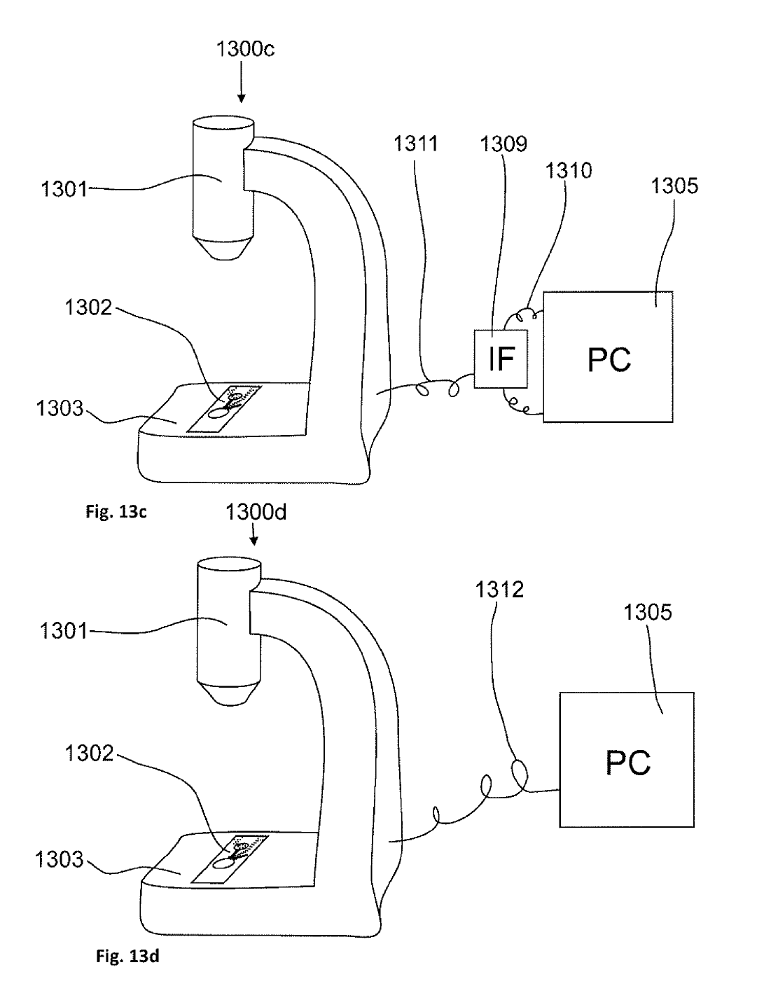

FIGS. 12a-12d show different geometries of a microfluidic device integrated on a respective microscope slide along with different control systems. The system comprises a substrate 1201, which may be of standard size, a target receptacle 1202, a source receptacle 1203, a counter electrode 1204, contact pads 1205, slide-interface connection wires 1206, a slide interface 1207, a working electrode 1208, an air vent outlet 1209, a channel inlet 1210, on-slide integrated circuits 1211 and wireless communication sender/receiver 1212, 1213.

The interface may be used to control the on-slide electronic valve activation via for example a PC control panel.

FIG. 12a shows a wired slide-interface connection where the electroactive valve is activated by a potential being applied to the circuit. This setup has two wires per electroactive valve and is used for simple slide designs.

FIG. 12b shows a slide with integrated circuits and an antenna that is in wireless communication with a control interface. The integrated circuits may control any number of valves.

FIG. 12c shows a wired slide-interface connection where integrated circuits on the slide are used to control a large number of valves. This is advantageous if the number of valves is high since it only utilizes two electrode contacts.

FIG. 12d shows a wired slide-interface connection where one wired connection is used per electroactive valve.

The number of both electrode connections and electroactive valves may be changed to fit the requirements of the specific application.

These embodiments show examples of how electronically controlled experiments are to be conducted in any microscope.

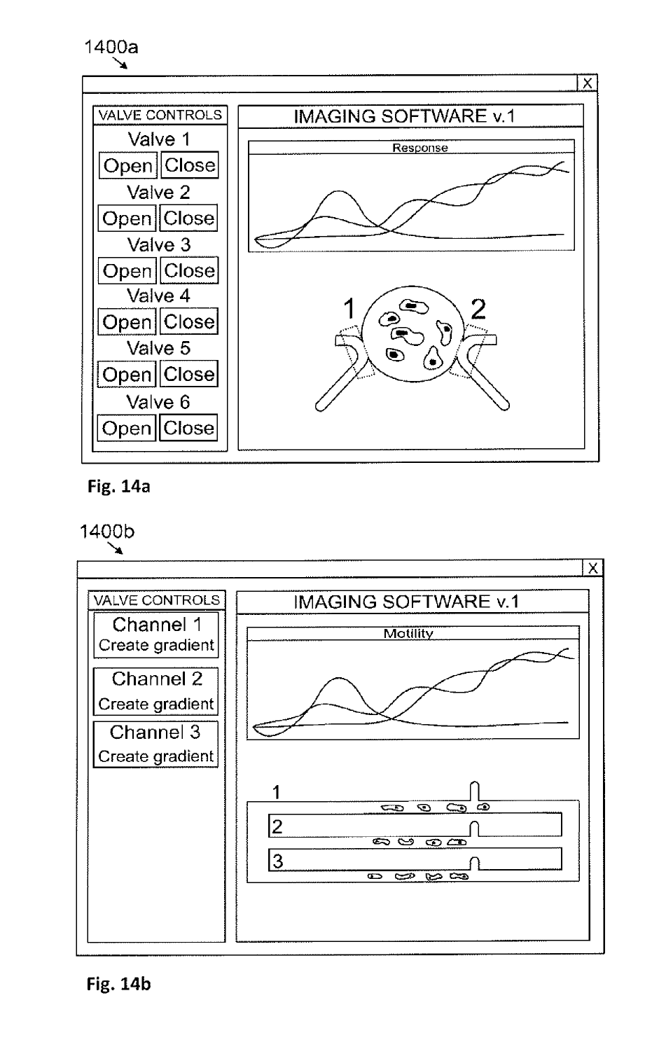

FIGS. 13a-13d show variations of a concept according to the present disclosure. The concept comprises a light microscope 1301, a microscope slide with an integrated microfluidic device and electrochemically active polymer valves 1302, sample holder 1303, built in slide-to-PC interface 1304, PC 1305, wired connection between interface and PC 1306, wireless connection between built-in interface and PC 1307, wireless sender/receiver 1308, separate interface 1309, connection between separate interface and computer 1310, connection between microscope and separate interface 1311 and connection directly between microscope and PC 1312.

When conducting experiments on a microscope slide in an ordinary light microscope it is now possible to control the addition of reagents to a confined volume that is under constant observation.

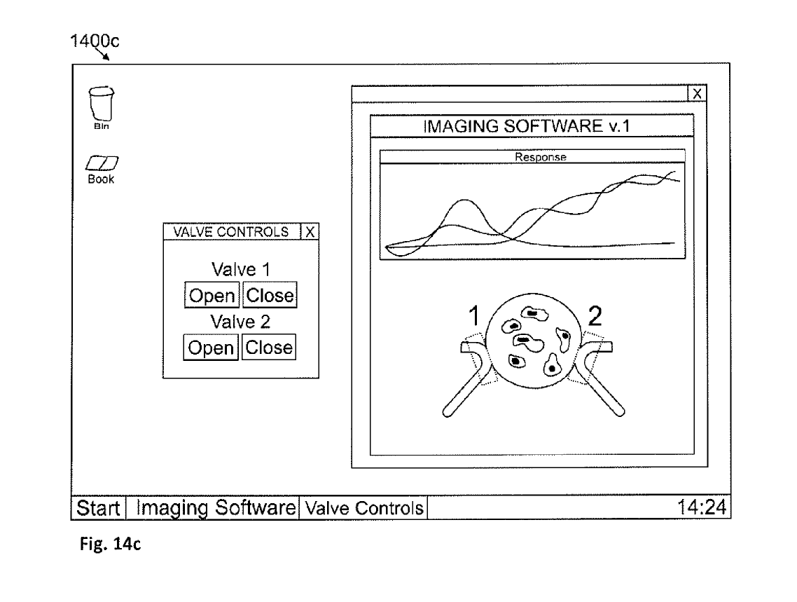

FIGS. 14a-14c illustrate how the concept and invention can be controlled from a computer program.

The control software may be integrated at any level in the system fabrication meaning that it can be delivered from start and added to an already existing system and anything in between.

FIGS. 14a-14b show the slide control panel integrated into an image acquisition and analysis software and 1400c shows the control panel as a software add-on running as a separate program.

This concept allows for new types of biological experiments where the dynamics of a complete cell response may be studied.

### EXAMPLE 1

NaOH was dissolved in DI water and put in the source receptacle 1103 of a microfluidic device according to FIG. 11a. The target receptacle 1102 was filled with thymol blue, a pH-indicator. The device was fitted in a microscope and the valve 1108 was activated. After a while the two liquids came into contact with each other. A clear pH-gradient could be seen propagating into the target receptacle. Hence, it is possible to utilize the microfluidic device to create chemical gradients in a controlled fashion. By changing the cross sectional area of the contact point the rate of diffusion may be controlled.

### EXAMPLE 2

Cells were allowed to adhere to cover glasses for 24 hrs. DMEM (cell medium) was put into the target receptacle of a microfluidic device according to FIG. 11a and the cell covered cover glass was placed upside down over the target receptacle. PBS (phosphate buffered saline) containing ionomycin was placed in the source receptacle and flowed into the channel and stopped at the valve. The device was placed in a microscope and the valve was activated. By monitoring the current through the device the exact time of contact between the two liquids could be established. The cell response to ionomycin diffusing in to the target receptacle was observed as changes in intracellular calcium. Hence, the microfluidic device can handle complex electrolyte solutions and works in adequate and interesting biological experiments.

1. A microfluidic device, comprising:
a valve having electrically controllable wetting properties,
the valve comprising a valve surface arranged in a closed valve space defined by at least the valve surface, a first liquid opening for leading a first liquid to the valve and a second liquid opening for leading a second liquid to the valve,
wherein the valve surface, in a first state, is sufficiently hydrophobic to prevent contact between the first liquid and the second liquid,
wherein the valve surface, in a second state, is sufficiently hydrophilic to allow contact between the first liquid and the second liquid, and
wherein a ventilation outlet is provided for allowing gas to escape from the valve space.

2. The microfluidic device as claimed in claim 1, wherein the valve surface comprises an electroactive polymer provided as a surface layer in at least a part of the valve space.

3. The microfluidic device as claimed in claim 1, wherein the valve space has a third opening forming the ventilation outlet and wherein the third opening is positioned outside a space spanned by the first and second openings.

4. The microfluidic device as claimed in claim 1, further comprising at least one receptacle and at least one channel, in fluid connection with the receptacle, wherein the channel and the receptacle define a main plane.

5. The microfluidic device as claimed in claim 4, wherein the channel is adapted to convey the second liquid mainly by capillary action.

6. The microfluidic device as claimed in claim 4, wherein the ventilation outlet opens in a direction substantially perpendicular to the main plane, or wherein the ventilation outlet opens in a direction substantially parallel with the main plane.

7. The microfluidic device as claimed in claim 4, wherein the receptacle is a target receptacle, adapted to hold the first liquid.

8. The microfluidic device as claimed in claim 7, wherein the valve is arranged in direct connection to the target receptacle.

9. The microfluidic device as claimed in claim 7, further comprising a source receptacle, which is connectable to the target receptacle via the channel and the valve.

10. A microfluidic device as claimed in claim 1, further comprising:
a main receptacle, adapted to receive the first liquid,
a main channel, extending from said main receptacle, and adapted to lead the first liquid from the main receptacle,
a branch channel, connected to a downstream point of the main channel and adapted to lead the second liquid to said downstream point of the main channel;
wherein the valve is arranged to control the flow of the second liquid to the main channel.

11. A method for controlling the interaction between a first and a second fluid in a microfluidic system, comprising:
separating the first liquid and the second liquids from each other by a closed valve space having a valve surface, which, in a first state, is sufficiently hydrophobic to prevent the first and second liquids from contacting each other, modifying the wettability of the valve surface to render it sufficiently hydrophilic to allow the first and second liquids to contact each other, and venting gas from the valve space.
